(19) United States
(12) Patent Application Publication
(10) Pub. No.: US 2025/0383297 A1
(43) Pub. Date: Dec. 18, 2025

(54) AUTOMATED DETECTION SYSTEM BASED ON AI VISION FOR FRUIT VESICLE ABNORMAL COLOR AND FOREIGN MATTER

(71) Applicant: Swire Coca-Cola Beverages Guangxi Limited, Nanning (CN)

(72) Inventors: Fang Feng, Nanning (CN); Tianfu Zhong, Nanning (CN); Caishi Yan, Nanning (CN); Wei Hu, Nanning (CN); Wancun Huang, Nanning (CN)

(21) Appl. No.: 19/004,172

(22) Filed: Dec. 27, 2024

(30) Foreign Application Priority Data
Jun. 18, 2024 (CN) 2024107837932

(51) Int. Cl. G01N 21/88; G06T 7/00; G06T 7/80; G06T 7/90; G06V 20/68

(52) U.S. Cl. CPC G01N 21/8851; G06T 7/0004; G06T 7/80; G06T 7/90; G06V 20/68; G06T 2207/30128

(57) ABSTRACT

An automated detection system based on AI vision for fruit vesicle abnormal color and foreign matter proposes to use a high-definition camera in combination with a microcomputer to collect high-frequency and high-definition photographs of surface of fruit vesicle raw material barrel when it's unpacked, analyze information, and then output detection results of each fruit vesicle raw material barrel, and accordingly realize demand for continued conveyance, early warning, elimination, and scrapping of the fruit vesicle raw material barrel, and replace the human eye in detecting smaller abnormal-color spots, which reduces the risk of foreign matter and abnormal color in the opening package of vesicle, and avoids food poisoning, allergic reaction or other health problems that may be caused by pests, chemical residues, mechanical damages and other reasons after being ingested into the human body, and protects health of the human body and food safety of consumers.

### 1. TECHNICAL FIELD

The invention belongs to the technical field of automated detection for fruit vesicle abnormal color and foreign matter, specifically relates to an automated detection system based on AI vision for fruit vesicle abnormal color and foreign matter.

### 2. BACKGROUND ART

Fruit vesicle abnormal color and foreign matter refers to abnormal substances that appear inside or on surface of the fruit vesicle and differ from the normal flesh color, shape, and texture. These abnormal color and foreign matter may be caused by pests, mechanical damage, physiological changes during growth or environmental factors. These foreign matter may affect the quality, taste and safety of fruits during food processing and consumer purchase, and therefore need to be detected and identified accurately. Therefore, it is of great significance to develop a method for the detection of foreign matter in fruit vesicles.

The existing methods for detecting abnormal color and foreign matter in fruit vesicle are unable to identify the foreign matter that may be contained in the fruit vesicle when the fruit vesicle is thawed and unpacked, and can only rely on simple visual inspection by the human eye, which is even more unable to identify the subtle foreign matter in the vesicle and the amount of foreign matter. The abnormal color and foreign matter in the fruit vesicle may be caused by pests, chemical residues, mechanical damage, etc., which may contain bacteria, viruses, pesticide residues or other harmful substances that are harmful to human beings, which may lead to food poisoning, allergic reactions or other health problems after being ingested into the human body, causing harm to human health and thus failing to protect the food safety of consumers. In addition, the foreign matter in the fruit vesicle may affect appearance of the product, reduce the acceptance and satisfaction of consumers, thus affecting the sales of the product, and may also damage the brand image and reputation of the enterprise.

### 3. SUMMARY OF THE INVENTION

In view of the above, in order to solve the problems raised in the above mentioned background art, the invention provides an automated detection system based on AI vision for fruit vesicle abnormal color and foreign matter.

The purpose of the invention can be achieved by the following technical solution: the invention provides an automated detection system based on AI vision for fruit vesicle abnormal color and foreign matter, including: a camera adjustment demand judgment module, a camera adjustment module, a raw material barrel position detection and analysis module, an abnormal color detection and analysis module, a foreign matter detection and analysis module, a detection result output module, a control module, and an information storage library.

The camera adjustment demand judgment module is connected to the camera adjustment module and the raw material barrel position detection and analysis module respectively, the raw material barrel position detection and analysis module is connected to the abnormal color detection and analysis module and the foreign matter detection and analysis module respectively, the detection result output module is connected to the abnormal color detection and analysis module and the foreign matter detection and analysis module respectively, the detection result output module is connected to the control module, and the information storage library is connected to the raw material barrel position detection and analysis module, the abnormal color detection and analysis module, the foreign matter detection and analysis module, and the detection result output module, respectively.

The camera adjustment demand judgment module is used to record fruit vesicle raw material barrel to be detected at detection position as a target fruit vesicle raw material barrel, and then analyze the position matching situation of it with the target camera, and determine the target camera adjustment needs.

The camera adjustment module is used to adjust the target camera when the camera adjustment demand is needing adjustment demand.

The raw material barrel position detection and analysis module is used to detect the position of each fruit vesicle raw material barrel to be detected, analyze the position match situation of it with the target camera, and judge the correction demand of the delivery position of the fruit vesicle raw material barrel to be detected, and further process it.

The abnormal color detection and analysis module is used for obtaining the abnormal color information parameter of each fruit vesicle of each fruit vesicle raw material barrel and analyzing it to obtain the abnormal color analysis result of each fruit vesicle of each fruit vesicle raw material barrel.

The foreign matter detection and analysis module is used to obtain the foreign matter information parameters of each fruit vesicle of each fruit vesicle raw material barrel, and analyze them to obtain foreign matter analysis result of each fruit vesicle of each fruit vesicle raw material barrel.

The detection result output module is used for outputting the detection result of each fruit vesicle raw material barrel, and accordingly analyze the next control requirement of each fruit vesicle raw material barrel, wherein the next control requirement include a demand for continued conveyance, a demand for elimination warning, and a demand for scrapping warning.

The control module is used to carry out control according to the next control demand of each fruit vesicle raw material barrel.

The information storage library is used to store the gray value of each pixel corresponding to the grayscale image of each abnormal-color spot, store the range of comprehensive risk coefficients corresponding to each risk level, and store the standard conveying position of the fruit vesicle raw material barrel to be detected.

Compared with the prior art, the beneficial effects of the invention are as follows: the invention proposes to use a high-definition camera in combination with a microcomputer to collect high-frequency and high-definition photographs of surface of the fruit vesicle raw material barrel when it's unpacked, analyze the information, and then output the detection results of each fruit vesicle raw material barrel, and accordingly realize the demand for continued conveyance, early warning, elimination, and scrapping of the fruit vesicle raw material barrel, and replace the human eye in detecting the smaller abnormal-color spots, which reduces the risk of foreign matter and abnormal color in the opening package of vesicle, and avoids food poisoning, allergic reaction or other health problems that may be caused by pests, chemical residues, mechanical damages and other reasons after being ingested into the human body, and protects health of the human body and food safety of consumers. To a certain extent, the appearance quality of the products is also guaranteed, which is conducive to improving consumers' acceptance and satisfaction of the products.

### 4. BRIEF DESCRIPTION OF ACCOMPANY DRAWINGS

In order to illustrate the preferred embodiment of the invention or the technical scheme more clearly, the drawings required by the embodiment is further described briefly. Obviously, only partial embodiments of the invention are shown and the actual structure is not limited thereto. It is to be understood by those skilled in the art that other drawings can be obtained based on the drawings of the invention with non-creative labor.

FIG. 1 is a connection diagram of system modules provided by the invention.

### 5. SPECIFIC EMBODIMENT OF THE INVENTION

The technical scheme of the invention is further described clearly and detailedly hereinafter with reference to the drawings. Obviously, only partial embodiments of the invention are shown and the actual structure is not limited thereto. All other embodiments, which can be obtained by those skilled in the art without making any creative effort based on the embodiments in the present invention, shall all fall within the protective scope of the invention.

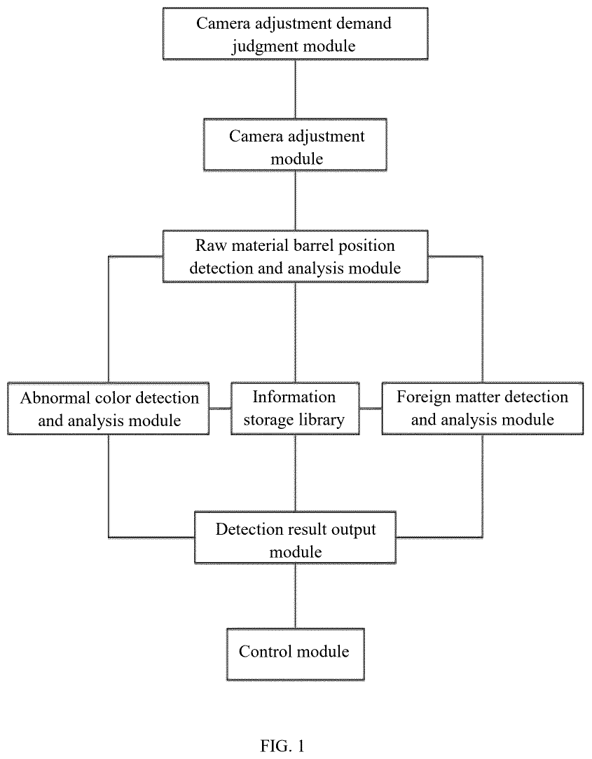

Referring to FIG. 1, the invention provides an automated detection system based on AI vision for fruit vesicle abnormal color and foreign matter, including: a camera adjustment demand judgment module, a camera adjustment module, a raw material barrel position detection and analysis module, an abnormal color detection and analysis module, a foreign matter detection and analysis module, a detection result output module, a control module, and an information storage library. Wherein, the connection modes of modules are as follows: the camera adjustment demand judgment module is connected to the camera adjustment module and the raw material barrel position detection and analysis module respectively, the raw material barrel position detection and analysis module is connected to the abnormal color detection and analysis module and the foreign matter detection and analysis module respectively, the detection result output module is connected to the abnormal color detection and analysis module and the foreign matter detection and analysis module respectively, the detection result output module is connected to the control module, and the information storage library is connected to the raw material barrel position detection and analysis module, the abnormal color detection and analysis module, the foreign matter detection and analysis module, and the detection result output module, respectively.

The camera adjustment demand judgment module is used to record fruit vesicle raw material barrel to be detected at detection position as a target fruit vesicle raw material barrel, and then analyze the position matching situation of it with the target camera, and determine the target camera adjustment needs.

It should be further clarified that the fruit vesicles are pulps of citrus segments, specifically referring to the orange vesicles after the oranges have been removed from the coating.

As a specific feasibility example, the position matching situation of the target fruit vesicle raw material barrel and the target camera are analyzed, specifically includes: a center point of the target fruit vesicle raw material barrel is set as a coordinate origin, a straight line passing the coordinate origin is made in a surface of the target fruit vesicle raw material barrel as a horizontal axis, and a straight line passing the coordinate origin and perpendicular to the horizontal axis is made as a vertical axis, and establish a two-dimensional coordinate system, and then get a coordinate of a center point of the target camera in the two-dimensional coordinate system established based on the target fruit vesicle raw material barrel, noted as (x, y), wherein x is a horizontal coordinate of the center point of the target camera, y is a vertical coordinate of the center point of the target camera.

If y=0, then the position of the target fruit vesicle raw material barrel matches the position of the target camera and the adjustment demand for the target camera is no adjustment demand, and if y≠0, then the position of the target fruit vesicle raw material barrel does not match the position of the target camera and the adjustment demand for the target camera is needing adjustment demand.

The camera adjustment module is used to adjust the target camera when the camera adjustment demand is needing adjustment demand.

As a specific feasibility example, the adjustment demand of the target camera is to adjust it when the adjustment demand is needing adjustment demand, and its specific operation includes: adjusting the position of the target camera so that the vertical coordinate of its center point is 0.

The raw material barrel position detection and analysis module is used to detect the position of each fruit vesicle raw material barrel to be detected, analyze the position match situation of it with the target camera, and judge the correction demand of the delivery position of the fruit vesicle raw material barrel to be detected, and further process it.

As a specific feasibility example, said position match situation of each fruit vesicle raw material barrel to be detected with the target camera can be analyzed in the following manner: in the same way of obtaining the coordinate of the center point of the target camera in the two-dimensional coordinate system established based on the target fruit vesicle raw material barrel, the coordinate of the center point of the target camera in the two-dimensional coordinate system established based on each fruit vesicle raw material barrel to be detected can be obtained, which are denoted as (xᵢ, yᵢ,), wherein i=1,2, . . . , a, i is the corresponding serial number of each fruit vesicle raw material barrel to be detected, a is the corresponding number of fruit vesicle raw material barrels to be detected, if y_{i,}=0, it means that the ith fruit vesicle raw material barrel to be detected matches the position of the target camera, if y_{i,}≠0, it means that the ith fruit vesicle raw material barrel to be detected does not match the position of the target camera, and then the number of fruit vesicle raw material barrels to be detected that match the position of the target camera is then counted and obtained as A; according to the formula

$$Mr = \frac{A}{a} ,$$

the position matching rate Mr between the fruit vesicle raw material barrels to be detected and the target camera is obtained.

The position matching rate between the fruit vesicle raw material barrels and the target camera is compared with the set matching rate threshold, and if it is greater than or equal to the set matching rate threshold, the correction demand for the delivery position of the fruit vesicle raw material barrels is recorded as no correction demand, and if it is not, the correction demand for the delivery position of the fruit vesicle raw material barrels is recorded as needing correction demand, and the correction process is carried out according to a predefined correction principle.

It is further clarified that said predefined correction principle consists of extracting the standardized conveying position of the fruit vesicle raw material barrels to be detected from the information storage library and correcting it by adjusting the speed or direction of the conveyor belt.

The abnormal color detection and analysis module is used for obtaining the abnormal color information parameter of each fruit vesicle of each fruit vesicle raw material barrel and analyzing it to obtain the abnormal color analysis result of each fruit vesicle of each fruit vesicle raw material barrel.

As a specific feasible example, the abnormal color information parameter of each fruit vesicle of each fruit vesicle raw material barrel includes all the abnormal-color spots on outer surface and interior.

It is to be further explained that the specific method of obtaining all the abnormal-color spots on outer surface and interior of each fruit vesicle of each fruit vesicle raw material barrel is to detect each fruit vesicle of each fruit vesicle raw material barrel by using the target camera to obtain all the abnormal-color spots on outer surface and interior of each fruit vesicle of each fruit vesicle raw material barrel.

As a specific feasible example, the abnormal color analysis result of each fruit vesicle of each fruit vesicle raw material barrel is obtained via the following specific analysis method: extracting all the abnormal-color spots on outer surface and interior of each fruit vesicle of each fruit vesicle raw material barrel, and further confirm all the abnormal-color spots on outer surface and interior of each fruit vesicle of each fruit vesicle raw material barrel, and and counting them to obtain the number of abnormal-color spots on the outer surface

$${Mspot}_{j}^{1} b$$

and the number of abnormal-color spots in the interior

$${Mspot}_{j}^{2} b$$

of each fruit vesicle of each fruit vesicle raw material barrel, wherein j=1,2, . . . , J, j is the serial number of each fruit vesicle raw material barrel, b=1,2, . . . , B, and b is the serial number of each fruit vesicle.

Analyze the abnormal color risk coefficient of each fruit vesicle of each fruit vesicle raw material barrel

$${NRC}_{jb} = {\frac{1}{5}}^{( \frac{1}{{Mspot}_{jb}^{1} + 1} + \frac{1}{{Mspot}_{jb}^{2} + 1} )} .$$

As a specific feasible example, determination of each abnormal-color spot on outer surface and interior of each fruit vesicle of each fruit vesicle raw material barrel includes: grayscaling each vesicle of each fruit vesicle raw material barrel with grayscale processing technology, obtaining a grayscale image of each abnormal-color spot on the outer surface of each fruit vesicle of each fruit vesicle raw material barrel, as well as each corresponding gray value of each pixel, and a grayscale image of each abnormal-color spot at interior of each fruit vesicle of each fruit vesicle raw material barrel, as well as each corresponding gray value of each pixel.

$$According to the analysis model , \\ {Yspot}_{jbf} = \{ \begin{matrix}Abnormal , {Y}_{1} ⋃ {Y}_{0} \neq {Y}_{0} \\ Nonabnormal , {Y}_{1} ⋃ {Y}_{0} = {Y}_{0}\end{matrix} ,$$

the anomalies of each abnormal-color spot on the outer surface of each fruit vesicle of each fruit vesicle raw material barrel are obtained as Yspot_{jbf}, wherein Y₁ is a set consisting of the gray value of each pixel belonging to each grayscale image of each abnormal-color spot on the outer surface of each fruit vesicle of each fruit vesicle raw material barrel as an element, and Y₀ is a set consisting of the gray value of each pixel belonging to each abnormal-color spot extracted from the information storage library, and U is the union set symbol, f=1,2, . . . , F, and f is the serial number of each abnormal-color spot on the outer surface, so that each abnormal-color spot on the outer surface of each fruit vesicle of each fruit vesicle raw material barrel can be determined.

As a specific example, the gray values of the corresponding pixels of the grayscale images of the abnormal-color spots on the outer surface of each fruit vesicle of each fruit vesicle raw material barrel are Gray_{jbf1}, Gray_{jbf2}, . . . , Gray_{jbft}, . . . , Gray_{jbfT,} wherein t=1,2, . . . , T, t is the serial number of each pixel corresponding to the grayscale image of the abnormal-color spot, T is the number of pixels corresponding to the grayscale image of the abnormal-color spots, and then elements of the set Y, are different values existing in Gray_{jbf1,} Gray_{jbf2}, . . . , Gray_{jbft}, . . . , Gray_{jbfT}.

It should be further noted that the set is a fundamental concept in mathematics, and is used to represent a group of objects that have some common properties. These objects are called elements of a set. Sets are characterized by determinism, mutual dissimilarity and disorder.

Determinism is defined as: given a set, given any element, the element either belongs to the set or does not belong to the set, and one of the two must be true, and no ambiguity is allowed.

Mutual dissimilarity is defined as: the elements of a set are different from each other, i.e. each element can only occur once.

Disorder is defined as: each element in a set has the same status, and there is no order among the elements. That is, the order of the elements in a set does not affect the set itself.

For further clarification, Y₁∪Y₀ denotes the union set of the set Y₁ and set Y₀, and the result is a set containing all the elements of Y₁ and Y₀.

Similarly, the abnormal-color spots in the interior of each fruit vesicle of each fruit vesicle raw material barrel can be determined.

The foreign matter detection and analysis module is used to obtain the foreign matter information parameters of each fruit vesicle of each fruit vesicle raw material barrel, and analyze them to obtain foreign matter analysis result of each fruit vesicle of each fruit vesicle raw material barrel.

As a specific feasible example, the foreign matter information parameters of each fruit vesicle of each fruit vesicle raw material barrel includes the number and volume of all types of foreign matters on the outer surface and the number and volume of all types of foreign matters in the interior.

It is to be further explained that the specific acquisition method of the foreign matter number and foreign matter volume of all types of foreign matters on the outer surface and the number and volume of all types of foreign matters in the interior of each fruit vesicle of each fruit vesicle raw material barrel comprises utilizing the target camera to inspect each fruit vesicle of each fruit vesicle raw material barrel so as to obtain the number and volume of all types of foreign matters on the outer surface and the number and volume of all types of foreign matters in the interior.

As a specific feasible example, the foreign matter analysis results of each fruit vesicle of each fruit vesicle raw material barrel are analyzed by extracting the number and volume of all types of foreign matters on the outer surface of each fruit vesicle raw material barrel and the number and volume of all types of foreign matters in the interior thereof, which are respectively recorded as

$${Mfm}_{jbh ,}^{1} {Vfm}_{jbhp}^{1} , {Mfm}_{jbg}^{2} , {Vfm}_{jbgq ,}^{2}$$

wherein h=1,2, . . . , H, and h is the serial number of all types of foreign matters on the outer surface; p=1,2, . . . , c, and p is the serial number of all foreign matters corresponding to the foreign matter category on the outer surface, and g=1,2, . . . , G, and g is the serial number of all types of foreign matters in the interior, q=1,2, . . . , Q, and q is the serial number of all foreign matters corresponding to the foreign matter category in the interior.

Analyzing the foreign matter risk coefficients of each fruit vesicle of each fruit vesicle raw material barrel,

$${FOR}_{jb} = {4}^{{\sum }_{h = 1}^{H} ( {Mfm}_{jbh}^{1} + {\sum }_{p = 1}^{c} \frac{{Vfm}_{jbhp}^{1}}{{Vfm}_{0}} ) + {\sum }_{g = 1}^{G} ( {Mfm}_{jbg}^{1} + {\sum }_{q = 1}^{Q} \frac{{Vfm}_{jbgq}^{2}}{{Vfm}_{0}} )}$$

wherein Vfm₀ is the permissible volume of the foreign matter.

The detection result output module is used for outputting the detection result of each fruit vesicle raw material barrel, and accordingly analyze the next control requirement of each fruit vesicle raw material barrel, wherein the next control requirement include a demand for continued conveyance, a demand for elimination warning, and a demand for scrapping warning.

As a specific feasibility example, the next control requirement of each fruit vesicle raw material barrel is analyzed by extracting the abnormal color risk coefficient and foreign matter risk coefficient of each fruit vesicle of each fruit vesicle raw material barrel, and calculating the comprehensive risk coefficient Cjb of each fruit vesicle of each fruit vesicle raw material barrel based on the following model

$${C}_{jb} = \frac{2}{π} * arctan ( 1 + {NRC}_{jb} + {FOR}_{jb} )$$

Match the comprehensive risk coefficient of each fruit vesicle of each fruit vesicle raw material barrel with a range of comprehensive risk coefficients corresponding to each risk level extracted from the information storage library to obtain the risk level of each fruit vesicle of each fruit vesicle raw material barrel, and then categorize the fruit vesicle of each fruit vesicle raw material barrel according to the risk level to obtain the fruit vesicle corresponding to the risk level of each fruit vesicle raw material barrel, and then count them to obtain the total number of fruit vesicles at each risk level of each fruit vesicle raw material barrel, making a ratio thereof to the total number of fruit vesicles of each fruit vesicle raw material barrel, and recording a quotient as the proportion of each risk level of each fruit vesicle raw material barrel.

It is further clarified that the risk level include no risk, low risk, medium risk and high risk.

Wherein, no risk means that the fruit vesicle is free of abnormal color and foreign matter. Low risk means that the fruit vesicle is slightly diseased or damaged, but does not affect the safety of the whole fruit for consumption. Medium risk indicates that the fruit vesicle is affected by disease. High risk indicates that the fruit vesicle is affected by a serious disease, e.g. rotting, mold growth, etc.

The next control requirement for each fruit vesicle raw material barrel are analyzed based on the proportion of all risk levels of fruit vesicle raw material barrels.

It should be further noted that the specific analysis of the next control requirement for each fruit vesicle raw material barrel based on the proportion of all risk levels of fruit vesicle raw material barrels is based on the following analysis: according to the analysis model

$${Need}_{j} = \{ \begin{matrix}{P}_{1} , {Risk}_{j}^{1} = 1 \\ {P}_{2} , {Risk}_{j}^{1} > {Risk}_{j}^{2} + {Risk}_{j}^{3} + {Risk}_{j}^{4} \\ {P}_{3} , {Risk}_{j}^{1} \leq {Risk}_{j}^{2} + {Risk}_{j}^{3} + {Risk}_{j}^{4}\end{matrix} ,$$

the next control requirement Needj for each fruit vesicle raw material barrel based on the proportion of all risk levels of fruit vesicle raw material barrels is obtained, wherein P₁ indicates a demand for continued conveyance, P₂ indicates a demand for elimination warning, P₃ indicates a demand for scrapping warning,

$${Risk}_{j}^{1} , {Risk}_{j}^{2} , {Risk}_{j}^{3} , {Risk}_{j}^{4}$$

are the proportions of a jth fruit vesicle raw material barrels belonging to no risk, low risk, medium risk and high risk respectively.

The control module is used to carry out control according to the next control demand of each fruit vesicle raw material barrel.

As a specific feasibility example, the control is performed according to the next control requirement of each fruit vesicle raw material barrel comprises: if the next control requirement of some fruit vesicle raw material barrel is a demand for continued conveyance, the fruit vesicle raw material barrel is continued to be conveyed.

If the next control requirement of some fruit vesicle raw material barrel is a demand for elimination warning, the fruit vesicle raw material barrel will carry out elimination warning, and will be transported to the elimination conveyor track.

If the next control requirement of some fruit vesicle raw material barrel is a demand for scrapping warning, the fruit vesicle raw material barrel will carry out scrapping warning, and will be transported to the scrapping conveyor track.

The information storage library is used to store the gray value of each pixel corresponding to the grayscale image of each abnormal-color spot, store the range of comprehensive risk coefficients corresponding to each risk level, and store the standard conveying position of the fruit vesicle raw material barrel to be detected.

The invention proposes to use a high-definition camera in combination with a microcomputer to collect high-frequency and high-definition photographs of surface of the fruit vesicle raw material barrel when it's unpacked, analyze the information, and then output the detection results of each fruit vesicle raw material barrel, and accordingly realize the demand for continued conveyance, early warning, elimination, and scrapping of the fruit vesicle raw material barrel, and replace the human eye in detecting the smaller abnormal-color spots, which reduces the risk of foreign matter and abnormal color in the opening package of vesicle, and avoids food poisoning, allergic reaction or other health problems that may be caused by pests, chemical residues, mechanical damages and other reasons after being ingested into the human body, and protects health of the human body and food safety of consumers. To a certain extent, the appearance quality of the products is also guaranteed, which is conducive to improving consumers' acceptance and satisfaction of the products.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. An automated detection system based on AI vision for fruit vesicle abnormal color and foreign matter, including:
a camera adjustment demand judgment module, used to record fruit vesicle raw material barrel to be detected at detection position as a target fruit vesicle raw material barrel, and then analyze the position matching situation of it with the target camera, and determine the target camera adjustment needs;
a camera adjustment module, used to adjust the target camera when the camera adjustment demand is needing adjustment demand;
a raw material barrel position detection and analysis module, used to detect the position of each fruit vesicle raw material barrel to be detected, analyze the position match situation of it with the target camera, and judge the correction demand of the delivery position of the fruit vesicle raw material barrel to be detected, and further process it;
an abnormal color detection and analysis module, used for obtaining the abnormal color information parameter of each fruit vesicle of each fruit vesicle raw material barrel and analyzing it to obtain the abnormal color analysis result of each fruit vesicle of each fruit vesicle raw material barrel;
a foreign matter detection and analysis module, used to obtain the foreign matter information parameters of each fruit vesicle of each fruit vesicle raw material barrel, and analyze them to obtain foreign matter analysis result of each fruit vesicle of each fruit vesicle raw material barrel;
a detection result output module, used for outputting the detection result of each fruit vesicle raw material barrel, and accordingly analyze the next control requirement of each fruit vesicle raw material barrel, wherein the next control requirement include a demand for continued conveyance, a demand for elimination warning, and a demand for scrapping warning;
a control module, used to carry out control according to the next control demand of each fruit vesicle raw material barrel; and
an information storage library, used to store the gray value of each pixel corresponding to the grayscale image of each abnormal-color spot, store the range of comprehensive risk coefficients corresponding to each risk level, and store the standard conveying position of the fruit vesicle raw material barrel to be detected.

2. The automated detection system based on AI vision for fruit vesicle abnormal color and foreign matter of claim 1, wherein the position matching situation of the target fruit vesicle raw material barrel and the target camera is analyzed, specifically includes:
a center point of the target fruit vesicle raw material barrel is set as a coordinate origin, a straight line passing the coordinate origin is made in a surface of the target fruit vesicle raw material barrel as a horizontal axis, and a straight line passing the coordinate origin and perpendicular to the horizontal axis is made as a vertical axis, and establish a two-dimensional coordinate system, and then get a coordinate of a center point of the target camera in the two-dimensional coordinate system established based on the target fruit vesicle raw material barrel, noted as (x, y), wherein x is a horizontal coordinate of the center point of the target camera, y is a vertical coordinate of the center point of the target camera;
if y=0, then the position of the target fruit vesicle raw material barrel matches the position of the target camera and the adjustment demand for the target camera is no adjustment demand, and if y≠0, then the position of the target fruit vesicle raw material barrel does not match the position of the target camera and the adjustment demand for the target camera is needing adjustment demand.

3. The automated detection system based on AI vision for fruit vesicle abnormal color and foreign matter of claim 2, wherein the adjustment demand of the target camera is to adjust it when the adjustment demand is needing adjustment demand, and its specific operation includes:
adjusting the position of the target camera so that the vertical coordinate of its center point is 0.

4. The automated detection system based on AI vision for fruit vesicle abnormal color and foreign matter of claim 2, wherein said position match situation of each fruit vesicle raw material barrel to be detected with the target camera can be analyzed in the following manner:
in the same way of obtaining the coordinate of the center point of the target camera in the two-dimensional coordinate system established based on the target fruit vesicle raw material barrel, the coordinate of the center point of the target camera in the two-dimensional coordinate system established based on each fruit vesicle raw material barrel to be detected can be obtained, which are denoted as (xᵢ, yᵢ,), wherein i=1, 2, . . . , a, i is the corresponding serial number of each fruit vesicle raw material barrel to be detected, a is the corresponding number of fruit vesicle raw material barrels to be detected, if y_{i,}=0, it means that the ith fruit vesicle raw material barrel to be detected matches the position of the target camera, if y_{i,}≠0, it means that the ith fruit vesicle raw material barrel to be detected does not match the position of the target camera, and then the number of fruit vesicle raw material barrels to be detected that match the position of the target camera is then counted and obtained as A; according to the formula
$$Mr = \frac{A}{a} ,$$
the position matching rate Mr between the fruit vesicle raw material barrels to be detected and the target camera is obtained;
the position matching rate between the fruit vesicle raw material barrels and the target camera is compared with the set matching rate threshold, and if it is greater than or equal to the set matching rate threshold, the correction demand for the delivery position of the fruit vesicle raw material barrels is recorded as no correction demand, and if it is not, the correction demand for the delivery position of the fruit vesicle raw material barrels is recorded as needing correction demand, and the correction process is carried out according to a predefined correction principle.

5. The automated detection system based on AI vision for fruit vesicle abnormal color and foreign matter of claim 1, wherein the abnormal color information parameter of each fruit vesicle of each fruit vesicle raw material barrel includes all the abnormal-color spots on outer surface and interior;
the foreign matter information parameters of each fruit vesicle of each fruit vesicle raw material barrel includes the number and volume of all types of foreign matters on the outer surface and the number and volume of all types of foreign matters in the interior.

6. The automated detection system based on AI vision for fruit vesicle abnormal color and foreign matter of claim 5, wherein the abnormal color analysis result of each fruit vesicle of each fruit vesicle raw material barrel is obtained via the following specific analysis method:
extracting all the abnormal-color spots on outer surface and interior of each fruit vesicle of each fruit vesicle raw material barrel, and further confirm all the abnormal-color spots on outer surface and interior of each fruit vesicle of each fruit vesicle raw material barrel, and counting them to obtain the number of abnormal-color spots on the outer surface
$${Mspot}_{j}^{1} b$$
and the number of abnormal-color spots in the interior
$${Mspot}_{j}^{2} b$$
of each fruit vesicle of each fruit vesicle raw material barrel, wherein j=1,2, . . . , J, j is the serial number of each fruit vesicle raw material barrel, b=1,2, . . . , B, and b is the serial number of each fruit vesicle;
analyze the abnormal color risk coefficient of each fruit vesicle of each fruit vesicle raw material barrel
$${NRC}_{jb} = {\frac{1}{5}}^{( \frac{1}{{Mspot}_{jb}^{1} + 1} + \frac{1}{{Mspot}_{jb}^{2} + 1} )} .$$

7. The automated detection system based on AI vision for fruit vesicle abnormal color and foreign matter of claim 6, wherein determination of each abnormal-color spot on outer surface and interior of each fruit vesicle of each fruit vesicle raw material barrel includes:
grayscaling each vesicle of each fruit vesicle raw material barrel with grayscale processing technology, obtaining a grayscale image of each abnormal-color spot on the outer surface of each fruit vesicle of each fruit vesicle raw material barrel, as well as each corresponding gray value of each pixel, and a grayscale image of each abnormal-color spot at interior of each fruit vesicle of each fruit vesicle raw material barrel, as well as each corresponding gray value of each pixel;
according to the analysis model,
$${Yspot}_{jbf} = \{ \begin{matrix}Abnormal , {Y}_{1} ⋃ {Y}_{0} \neq {Y}_{0} \\ Nonabnormal , {Y}_{1} ⋃ {Y}_{0} = {Y}_{0}\end{matrix}$$
the anomalies of each abnormal-color spot on the outer surface of each fruit vesicle of each fruit vesicle raw material barrel are obtained as Yspot_{jbf}, wherein Y₁ is a set consisting of the gray value of each pixel belonging to each grayscale image of each abnormal-color spot on the outer surface of each fruit vesicle of each fruit vesicle raw material barrel as an element, and Y₀ is a set consisting of the gray value of each pixel belonging to each abnormal-color spot extracted from the information storage library, and U is the union set symbol, f=1,2, . . . , F, and f is the serial number of each abnormal-color spot on the outer surface, so that each abnormal-color spot on the outer surface of each fruit vesicle of each fruit vesicle raw material barrel can be determined;
similarly, the abnormal-color spots in the interior of each fruit vesicle of each fruit vesicle raw material barrel can be determined.

8. The automated detection system based on AI vision for fruit vesicle abnormal color and foreign matter of claim 6, wherein the foreign matter analysis results of each fruit vesicle of each fruit vesicle raw material barrel are analyzed as follows:
extracting the number and volume of all types of foreign matters on the outer surface of each fruit vesicle raw material barrel and the number and volume of all types of foreign matters in the interior thereof, which are respectively recorded as
$${Mfm}_{jbh ,}^{1} {Vfm}_{jbhp}^{1} , {Mfm}_{jbg}^{2} , {Vfm}_{jbgq ,}^{2}$$
wherein h=1,2, . . . , H, and h is the serial number of all types of foreign matters on the outer surface; p=1,2, . . . , c, and p is the serial number of all foreign matters corresponding to the foreign matter category on the outer surface, and g=1,2, . . . , G, and g is the serial number of all types of foreign matters in the interior, q=1,2, . . . , Q, and q is the serial number of all foreign matters corresponding to the foreign matter category in the interior;
analyzing the foreign matter risk coefficients of each fruit vesicle of each fruit vesicle raw material barrel,
$${FOR}_{\underline{jb}} = {4}^{{\sum }_{h = 1}^{H} ( {Mfm}_{jbh}^{1} + {\sum }_{p = 1}^{c} \frac{{Vfm}_{jbhp}^{1}}{{Vfm}_{0}} ) + {\sum }_{g = 1}^{G} ( {Mfm}_{jbg}^{1} + {\sum }_{q = 1}^{Q} \frac{{Vfm}_{jbgq}^{2}}{{Vfm}_{0}} )}$$
wherein Vfm₀ is the permissible volume of the foreign matter.

9. The automated detection system based on AI vision for fruit vesicle abnormal color and foreign matter of claim 8, wherein the next control requirement of each fruit vesicle raw material barrel is analyzed as follows:
extracting the abnormal color risk coefficient and foreign matter risk coefficient of each fruit vesicle of each fruit vesicle raw material barrel, and calculating the comprehensive risk coefficient Cjb of each fruit vesicle of each fruit vesicle raw material barrel based on the following model:
$${C}_{jb} = \frac{2}{π} * arctan ( 1 + {NRC}_{jb} + {FOR}_{jb} ) ;$$
match the comprehensive risk coefficient of each fruit vesicle of each fruit vesicle raw material barrel with a range of comprehensive risk coefficients corresponding to each risk level extracted from the information storage library to obtain the risk level of each fruit vesicle of each fruit vesicle raw material barrel, and then categorize the fruit vesicle of each fruit vesicle raw material barrel according to the risk level to obtain the fruit vesicle corresponding to the risk level of each fruit vesicle raw material barrel, and then count them to obtain the total number of fruit vesicles at each risk level of each fruit vesicle raw material barrel, making a ratio thereof to the total number of fruit vesicles of each fruit vesicle raw material barrel, and recording a quotient as the proportion of each risk level of each fruit vesicle raw material barrel;
the next control requirement for each fruit vesicle raw material barrel are analyzed based on the proportion of all risk levels of fruit vesicle raw material barrels.

10. The automated detection system based on AI vision for fruit vesicle abnormal color and foreign matter of claim 9, wherein the control is performed according to the next control requirement of each fruit vesicle raw material barrel comprises:
if the next control requirement of some fruit vesicle raw material barrel is a demand for continued conveyance, the fruit vesicle raw material barrel is continued to be conveyed;
if the next control requirement of some fruit vesicle raw material barrel is a demand for elimination warning, the fruit vesicle raw material barrel will carry out elimination warning, and will be transported to the elimination conveyor track;
if the next control requirement of some fruit vesicle raw material barrel is a demand for scrapping warning, the fruit vesicle raw material barrel will carry out scrapping warning, and will be transported to the scrapping conveyor track.
